(19) United States
(12) Patent Application Publication
(10) Pub. No.: US 2026/0249836 A1
(43) Pub. Date: Aug. 27, 2026

(54) DRIVING FORCE CONTROL SYSTEM

(71) Applicant: TOYOTA JIDOSHA KABUSHIKI KAISHA, Toyota-shi (JP)

(72) Inventor: Ryosuke OKUBO, Yokohama-shi (JP)

(73) Assignee: TOYOTA JIDOSHA KABUSHIKI KAISHA, Toyota-shi (JP)

(21) Appl. No.: 19/404,679

(22) Filed: Dec. 1, 2025

(30) Foreign Application Priority Data
Feb. 26, 2025 (JP) 2025-028906

(51) Int. Cl. B60W 30/02

(52) U.S. Cl. CPC B60W 30/02; B60W 2520/26

(57) ABSTRACT

A state quantity acquisition unit acquires state quantities of each wheel. A driving stiffness acquisition unit acquires driving stiffness of each wheel based on the acquired state quantities. A driving force setting unit sets a driving force for each wheel, based on the driving stiffness of each wheel, so as to reduce total wheel loss of the wheels. A drive control unit drives each wheel according to the set driving force for each wheel.

### CROSS-REFERENCE TO RELATED APPLICATION

This application claims priority to Japanese Patent Application No. 2025-028906 filed on Feb. 26, 2025. The disclosure of the above-identified application, including the specification, drawings, and claims, is incorporated by reference herein in its entirety.

### BACKGROUND

### 1. Technical Field

The present disclosure relates to driving force control systems that independently control the driving force for a plurality of wheels of a vehicle.

### 2. Description of Related Art

Japanese Unexamined Patent Application Publication No. 2019-64415 (JP 2019-64415 A) discloses a driving force control method that distributes the driving force of a vehicle using an estimated maximum road surface. The driving force control method includes: a first estimation step of estimating the maximum road surface, during a first driving state in which the vehicle is accelerating steadily in a straight line, based on driving stiffness corresponding to the slip ratio and driving force; a second estimation step of estimating the maximum road surface, during a second driving state in which the vehicle is being steered, based on steering reaction force; and a third estimation step of estimating a preset maximum road surface, during a third driving state in which the outside air temperature is higher than or equal to a determination temperature.

### SUMMARY

When a wheel is driven or braked, drive loss due to slip occurs between the wheel and the road surface. In a battery electric vehicle, the drive loss at each wheel leads to excess power consumption, while in an internal combustion engine vehicle, it leads to a reduction in fuel efficiency. It is therefore an object of the present disclosure to provide a technology for efficiently distributing driving force to each wheel.

A driving force control system according to one aspect of the present disclosure is a system configured to independently control a driving force for a plurality of wheels of a vehicle. The driving force control system includes: a state quantity acquisition unit configured to acquire a state quantity of each of the wheels; a driving stiffness acquisition unit configured to acquire driving stiffness of each of the wheels based on the acquired state quantity; a driving force setting unit configured to set a driving force for each of the wheels, based on the driving stiffness of each of the wheels, so as to reduce total wheel loss of the wheels; and a drive control unit configured to drive each of the wheels according to the set driving force for each of the wheels.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a vehicle according to an embodiment;

FIG. 2 is a diagram illustrating drive loss that occurs at a wheel;

FIG. 3 is a diagram showing functional blocks of a driving force control system mounted on the vehicle; and

FIG. 4 is a flowchart illustrating a method for distributing driving force according to the embodiment.

### DETAILED DESCRIPTION OF EMBODIMENTS

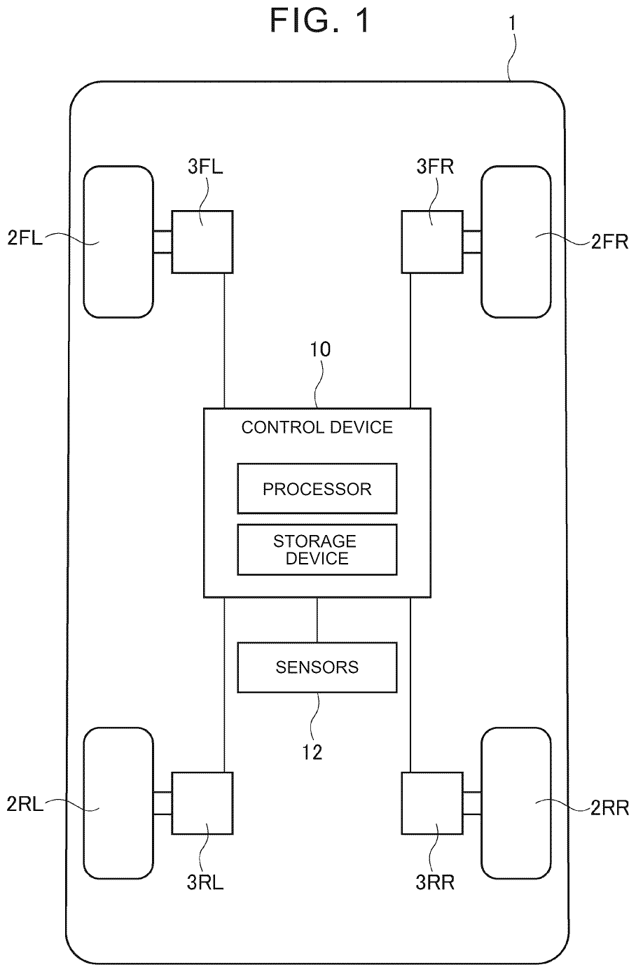

FIG. 1 schematically shows the configuration of a vehicle 1 according to an embodiment. The vehicle 1 includes a plurality of wheels and a plurality of electric motors provided for the wheels, and has a function to independently control the driving force for the wheels. The wheels include a left front wheel 2FL, a right front wheel 2FR, a left rear wheel 2RL, and a right rear wheel 2RR. The electric motors include an electric motor 3FL for rotating the left front wheel 2FL, an electric motor 3FR for rotating the right front wheel 2FR, an electric motor 3RL for rotating the left rear wheel 2RL, and an electric motor 3RR for rotating the right rear wheel 2RR. Unless otherwise distinguished, the wheels will be collectively referred to as wheels 2, and the electric motors are collectively referred to as electric motors 3.

The vehicle 1 according to the embodiment is an electrified vehicle that uses the electric motors 3 as its drive power source for traveling. However, the vehicle may be a vehicle that uses an internal combustion engine as its drive power source for traveling. Examples of the electrified vehicle include a battery electric vehicle (BEV), a hybrid electric vehicle (HEV), a plug-in hybrid electric vehicle (PHEV), and a fuel cell electric vehicle (FCEV). The vehicle 1 may be a vehicle driven by a driver, or may be an autonomous vehicle. Even when the vehicle 1 uses an internal combustion engine as its drive power source for traveling, the vehicle 1 is provided with the function to independently control the driving force for the wheels 2.

The vehicle 1 includes a control device 10 that includes a processor, a storage device, and an input and output interface. The input and output interface receives sensor signals measured by various sensors included in sensors 12 provided in the vehicle 1. The storage device stores a control program and control data such as maps for setting the driving force for each wheel 2 and controlling each electric motor 3. The processor reads and executes the control program from the storage device, thereby implementing control that optimally distributes the driving force to the wheels 2.

The sensors 12 include means for measuring state quantities of the vehicle 1. In the embodiment, the sensors 12 include means for measuring the temperature of each wheel 2. The means for measuring wheel temperature may be a temperature sensor provided inside the wheel 2. The sensors 12 also include means for measuring the load on each wheel 2, or means for measuring state quantities for estimating the load on each wheel 2. The means for measuring wheel load may be a load sensor that measures the wheel load, and the means for measuring state quantities for estimating the wheel load may be a stroke sensor that measures the stroke amount of the suspension. In this case, the processor may have a function to estimate the wheel load from the stroke amount. The sensors 12 further include means for measuring state quantities for estimating the slip angle of each wheel 2. The means for measuring state quantities for estimating the slip angle may be a wheel speed sensor that measures wheel speed and a lateral acceleration sensor that detects lateral acceleration. In this case, the processor may have a function to estimate the slip angle from the vehicle speed and an integrated value of the lateral acceleration. The processor may also have a function to estimate the slip angle from measured values of a global positioning system (GPS) and a tire angle sensor.

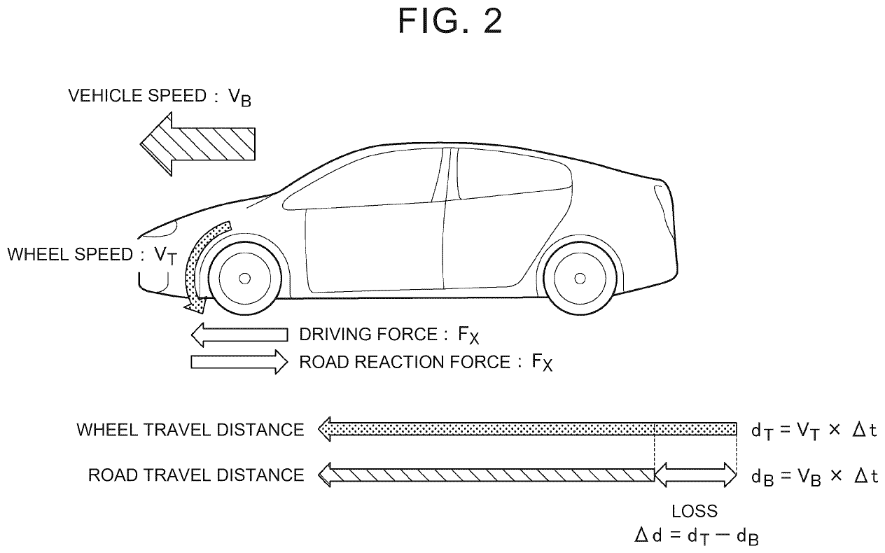

FIG. 2 is a diagram illustrating drive loss that occurs at a wheel. The rotational speed of the wheel (wheel speed) is herein denoted as V_{T}, and the ground speed (road speed) of the vehicle is denoted as V_{B}. According to the law of action and reaction, the driving force F_{X} and the road reaction force F_{X} are equal.

The travel distance d_{T} of the wheel and the travel distance d_{B} on the road during a time Δt are calculated as follows.
Wheel travel distance d_{T}=V_{T}×Δt
Road travel distance d_{B}=V_{B}×Δt

Considering the work, the work of the wheel is given by driving force F_{X}×wheel travel distance d_{T}, and the work of the road surface is given by road reaction force F_{X}×road travel distance d_{B}. Accordingly, the power of the wheel (wheel work/Δt) is given by driving force F_{X}×wheel speed V_{T}, and the power of the road surface (road work/Δt) is given by road reaction force F_{X}×road speed V_{B}. Therefore, the loss P_{X} between the wheel and the road surface is expressed as follows.
P_{X}=F_{X}×V_{T}−F_{X}×V_{B}
=F_{X}×(V_{T}−V_{B})
=F_{X}×{(V_{T}−V_{B})/V_{B}}×V_{B}
   Since (V_{T}−V_{B})/V_{B} is the slip ratio SR, the loss P_{X} is given by the following expression (1).

$${P}_{X} = {F}_{X} \times SR \times {V}_{B} \qquad ( 1 )$$

The loss P_{X} is the drive loss (wheel loss) that occurs at one wheel.

Accordingly, the loss P_{X} of each wheel 2 can be given by the following expression (2).

$${P}_{Xi} = {F}_{Xi} \times SR \times {V}_{B} \qquad ( 2 )$$

where “i” is a number distinguishing the wheels 2. For example, “1” denotes the left front wheel 2FL, “2” denotes the right front wheel 2FR, “3” denotes the left rear wheel 2RL, and “4” denotes the right rear wheel 2RR. When the requested driving force of the vehicle 1 is denoted by F, F is given by the following expression (3).

$$F = {Σ F}_{xi} = {F}_{1} + {F}_{2} + {F}_{3} + {F}_{4} \qquad ( 3 )$$

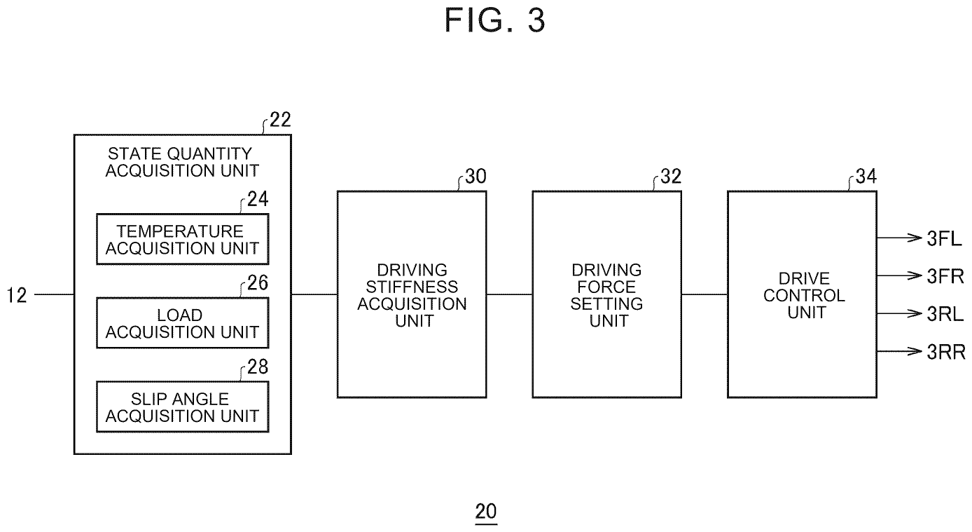

FIG. 3 shows functional blocks of a driving force control system mounted on the vehicle. A driving force control system 20 has a function to independently control the driving force for the wheels 2, and includes a state quantity acquisition unit 22, a driving stiffness acquisition unit 30, a driving force setting unit 32, and a drive control unit 34. The functions of the driving force control system 20 may be implemented by the control device 10.

The state quantity acquisition unit 22 acquires state quantities of the wheels 2 based on sensor signals (measured values) provided from various sensors included in the sensors 12. The state quantity acquisition unit 22 includes a temperature acquisition unit 24, a load acquisition unit 26, and a slip angle acquisition unit 28. The temperature acquisition unit 24 acquires the wheel temperature Tᵢ of each wheel 2, the load acquisition unit 26 acquires the wheel load Wᵢ on each wheel 2, and the slip angle acquisition unit 28 acquires the wheel slip angle SAᵢ of each wheel 2.

The temperature acquisition unit 24 may acquire the wheel temperature Tᵢ from measured values of a temperature sensor provided inside the wheel 2. The load acquisition unit 26 may calculate and acquire the load Wᵢ on the wheel 2 from measured values of the stroke sensor. The slip angle acquisition unit 28 may calculate and acquire the slip angle SAᵢ from measured values of a wheel speed sensor and a lateral acceleration sensor.

In a region where the slip ratio SR is small, the driving force F_{X} is in an approximately linear relationship with the slip ratio SR, and the proportional constant at this time is called driving stiffness DS. Accordingly, the driving stiffness DSᵢ of each wheel 2 is defined by the following expression (4).

$${F}_{Xi} = {DS}_{i} \times SR \qquad ( 4 )$$

The driving stiffness acquisition unit 30 acquires the driving stiffness DSᵢ of each wheel 2 based on the state quantities acquired by the state quantity acquisition unit 22. In the embodiment, the driving stiffness acquisition unit 30 acquires the driving stiffness DSᵢ of each wheel 2 based on the acquired wheel temperature Tᵢ, wheel load Wᵢ, and wheel slip angle SAᵢ. The driving stiffness acquisition unit 30 may derive the driving stiffness DSᵢ of each wheel 2 using means such as a map that defines the relationship between the driving stiffness DSᵢ and each state quantity.

$${DS}_{i} = f ( {T}_{i} , {W}_{i} , {SA}_{i} ) \qquad ( 5 )$$

The driving stiffness acquisition unit 30 may acquire the driving stiffness DSᵢ of each wheel 2 using a known map that defines the relationship between the wheel temperature, wheel load, and wheel slip angle, and the driving stiffness.

The driving force setting unit 32 sets the driving force F_{Xi} for each wheel 2, based on the driving stiffness DSᵢ of each wheel 2, so as to reduce the total wheel loss of the wheels 2.

From expressions (2) and (4), the loss P_{Xi} of each wheel 2 is given by the following expression (6).

$${P}_{Xi} = {F}_{Xi} \times ( {F}_{Xi} / {DS}_{i} ) \times {V}_{B} = {{F}_{Xi}}^{2} \times {V}_{B} / {DS}_{i} \qquad ( 6 )$$

Accordingly, the total wheel loss P of all the wheels 2 is calculated by the following expression (7).

$$\begin{matrix}( Math . 1 ) & \\ P = {\sum }_{i} \frac{{{F}_{xi}}^{2}}{{DS}_{i}} \cdot {V}_{B} & ( 7 )\end{matrix}$$

The driving force setting unit 32 sets the driving force F_{Xi} for each wheel 2 so as to minimize the total wheel loss P calculated by expression (7). Specifically, the driving force setting unit 32 distributes the requested driving force F of the vehicle 1, derived based on the accelerator operation amount and the vehicle speed, to the wheels 2 so as to minimize the total drive loss (wheel loss) P of all the wheels 2, and sets the driving force F_{Xi} for each wheel 2. The drive control unit 34 drives each wheel 2 according to the set driving force of each wheel 2. Specifically, the drive control unit 34 controls each electric motor 3 according to the set driving force of each wheel 2. As described above, according to the embodiment, the driving force setting unit 32 sets the driving force F_{Xi} of each wheel 2 so as to reduce the total wheel loss P. Therefore, in a battery electric vehicle, excess power consumption can be avoided, and in an internal combustion engine vehicle, a reduction in fuel efficiency can be avoided.

The occurrence of oversteer as a result of distributing the driving force is undesirable from the viewpoint of stable travel of the vehicle. Accordingly, the driving force setting unit 32 may have a function to determine whether oversteer will occur when the set driving force F_{Xi} is applied to each wheel 2.

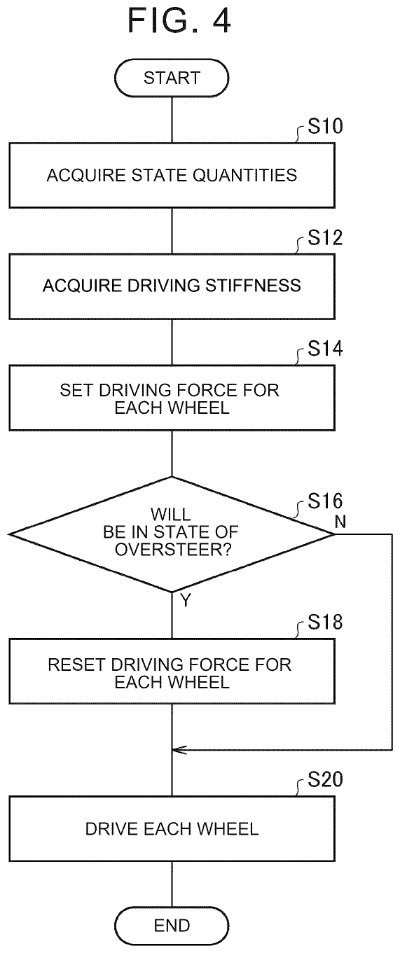

FIG. 4 is a flowchart of a method for distributing driving force according to the embodiment. The state quantity acquisition unit 22 acquires state quantities of each wheel 2 (S10). In the embodiment, the state quantity acquisition unit 22 may acquire the wheel temperature Tᵢ, the wheel load Wᵢ, and the wheel slip angle SAᵢ at predetermined intervals. The driving stiffness acquisition unit 30 acquires the driving stiffness DSᵢ of each wheel 2 based on the acquired state quantities (S12). The driving stiffness acquisition unit 30 may acquire the driving stiffness DSᵢ using a map etc. The driving force setting unit 32 sets the driving force for each wheel 2, based on the driving stiffness DSᵢ of each wheel 2, so as to reduce the total wheel loss of the wheels 2 (S14).

At this time, the driving force setting unit 32 determines whether the vehicle 1 will be in a state of oversteer when the set driving force is applied to each wheel 2 (S16). In this step, the driving force setting unit 32 derives the cornering power CPᵢ of each wheel 2 when the set driving force is applied. For example, the driving force setting unit 32 may derive the cornering power CPᵢ of each wheel 2 using a map that defines the relationship between state quantities and cornering power. The driving force setting unit 32 then calculates a stability factor K of the vehicle 1 using, for example, expression (8).

$$\begin{matrix}( Math . 2 ) & \\ K = \frac{1}{l \cdot g} ( \frac{1}{{C}_{F}} - \frac{1}{{C}_{R}} ) & ( 8 )\end{matrix}$$

$${C}_{i} = {e}_{i} \cdot {CP}_{i}$$

$${CP}_{i} : normalized cornering power ( CP ) of the i - th wheel$$

$${e}_{i} : CP amplification factor of the i - th wheel$$

$${C}_{i} : equivalent CP of the i - th vehicle$$

$${C}_{F} : average equivalent CP of the two front wheels$$

$${C}_{R} : average equivalent CP of the two rear wheels$$

$$I : wheelbase$$

$$g : gravitational acceleration$$

The stability factor K is a characteristic value that indicates the steering state of the vehicle. A positive stability factor K indicates that the vehicle is in a state of understeer, and a negative stability factor K indicates that the vehicle is in a state of oversteer. When the vehicle will be in a state of understeer (N in S16), stable travel of the vehicle 1 can be realized. Accordingly, the drive control unit 34 controls each electric motor 3 according to the driving force for each wheel 2 as set by the driving force setting unit 32 (S20).

On the other hand, when the vehicle will be in a state of oversteer (Y in S16), the driving force setting unit 32 determines that stable travel cannot be realized if the set driving force is applied to each wheel 2, and modifies and resets the set driving force for each wheel 2 (S18). Specifically, the driving force setting unit 32 modifies and resets the set driving force such that the vehicle 1 exhibits an understeer characteristic. The drive control unit 34 then controls each electric motor 3 according to the driving force for each wheel 2 as reset by the driving force setting unit 32 (S20). In this way, the driving force control system 20 can realize stable travel of the vehicle 1.

The present disclosure has been described above based on the embodiment. The embodiment is merely illustrative, and it will be understood by those skilled in the art that various modifications of the combinations of the components and processing steps are possible, and that such modifications also fall within the scope of the present disclosure.

What is claimed is:

1. A driving force control system configured to independently control a driving force for a plurality of wheels of a vehicle, the driving force control system comprising:
a state quantity acquisition unit configured to acquire a state quantity of each of the wheels;
a driving stiffness acquisition unit configured to acquire driving stiffness of each of the wheels based on the acquired state quantity;
a driving force setting unit configured to set a driving force for each of the wheels, based on the driving stiffness of each of the wheels, so as to reduce total wheel loss of the wheels; and
a drive control unit configured to drive each of the wheels according to the set driving force for each of the wheels.

2. The driving force control system according to claim 1, wherein:
the state quantity acquisition unit includes
a temperature acquisition unit configured to acquire a wheel temperature of each of the wheels,
a load acquisition unit configured to acquire a wheel load of each of the wheels, and
a slip angle acquisition unit configured to acquire a wheel slip angle of each of the wheels; and
the driving stiffness acquisition unit is configured to acquire the driving stiffness of each of the wheels based on the acquired wheel temperature, the acquired wheel load, and the acquired wheel slip angle.

3. The driving force control system according to claim 1, wherein the driving force setting unit is configured to derive the driving force for each of the wheels so as to minimize the total wheel loss of the wheels.

4. The driving force control system according to claim 1, wherein the driving force setting unit is configured to modify the set driving force in a case where application of the set driving force to each of the wheels causes the vehicle to be in a state of oversteer.

5. The driving force control system according to claim 4, wherein the driving force setting unit is configured to modify the set driving force so as to cause the vehicle to be in a state of understeer.
